(19) United States
(12) Patent Application Publication
(10) Pub. No.: US 2012/0024553 A1
(43) Pub. Date: Feb. 2, 2012

(54) Implement and tool for loosening connection elements and kit comprising such implement

(76) Inventor: Pierluigi Speranza, Fiave' (TN) (IT)

(21) Appl. No.: 13/147,573

(22) PCT Filed: Feb. 4, 2010
(86) PCT No.: PCT/IB2010/050522

§ 371 Date: Aug. 5, 2011

(30) Foreign Application Priority Data
Feb. 4, 2009 (SM) SM-A-200900008

(51) Int. Cl. B25D 17/02; B25D 17/08

(52) U.S. Cl. 173/90; 81/464

(57) ABSTRACT

An implement for loosening stuck connection elements includes a striker hammer with a connecting portion for connection to a percussion tool at one end, and a striking surface for imparting an impulsive stress at the other end; a counteracting body opposing the striker and having an abutment surface that faces towards the striking surface; a retainer for retaining the striker to the counteracting body, while keeping a predetermined minimum distance between the striking surface and the abutment surface (8), so adapted to accommodate at least one of the elements of a pair to be loosened. A combination of the implement with a percussion tool and/or a wrench.

### FIELD OF THE INVENTION

The present invention generally finds application in the field of handheld tools and particularly relates to a percussion implement for loosening stuck connection elements, such as threaded couplings.

The invention further relates to a percussion tool that incorporates such implement.

### BACKGROUND ART

In general mechanics, and particularly in the automotive field, removable connection members, with threaded couplings or elements, such as nuts or bolts, but possibly of different types, such as broaches or pins are known to become often stuck.

In this case, any servicing or maintenance requires loosening of the elements of the pair by suitable removal techniques and tools.

These tools are intended to impart mechanical stresses, e.g. a torque, to one or both of the pair elements to cause uncoupling.

Typically, electrical tools are used for this purpose, which have a specially shaped head adapted for engagement with a matingly shaped portion of one of the two elements of the pair for imparting the required torque.

These solutions have a number of drawbacks, the most common of which is poor effectiveness of the tool in case of stuck couplings due to oxidized threads or partial interpenetration thereof.

Here, the use of rust removing solvents may be ineffective, and thus require impulsive stresses to be imparted to break the layer of oxide between the two coupled surfaces for solvent penetration.

Certain manual techniques, particularly used in car repairs, involve the use of two strikers on the coupling from opposite sides.

Particularly, one of the striker is used as an anvil and is held still in contact with a first element of the pair, whereas the other striker is used by the operator to impart the impulsive loosening stress.

Nevertheless, there is very little space available to the operator, which makes the operation unpractical.

For instance, for wheel alignment in a car, with the vehicle possibly placed on a lift, the dowel pin may happen to be stuck and require some manual action.

This may require the car to be further hoisted from the lift for wheel removal, which will extend the duration of the process and increase its costs.

### DISCLOSURE OF THE INVENTION

The object of the present invention is to obviate the above drawbacks, by providing an implement for loosening coupled connection elements of either threaded or interlock or interference type, that is both inexpensive and simple to use.

A particular object of the present invention is to provide an implement for loosening connection elements that may be used even in small and hardly accessible spaces.

Another object of the invention is to provide an implement for loosening coupled connection elements that may be used for servicing a vehicle with two or more wheels while maintaining the vehicle in the driving position.

Another important object of the invention is to provide a power-operated tool for loosening threaded couplings, that can ensure a quick and simple loosening effect, even in restricted operation spaces.

These and other objects, as better explained hereafter, are fulfilled by an implement for loosening coupled connection elements as defined in claim 1.

With the implement of the invention, a threaded coupling may be loosened even in a very small space.

Furthermore, in the case of a vehicle with two or more wheels, the wheels will not need to be removed.

In a further aspect, the invention provides a kit for loosening connection elements, which comprises an implement of the present invention, an auxiliary wrench for use with the implement, operating on one of the elements to be loosened, and possibly a percussion tool designed to be connected to the implement.

The wrench may be also used without the implement and the percussion tool.

Advantageous embodiments of the invention are defined in accordance with the dependent claims.

### BRIEF DESCRIPTION OF THE DRAWINGS

Further features and advantages of the invention will be more apparent from the detailed description of certain preferred, non-exclusive embodiments of an implement and a tool according to the invention and a wrench that is part of a loosening kit according to the invention, which are described as a non-limiting example with the help of the annexed drawings, in which:

FIG. 1 is an exploded perspective view of an implement of the invention;

FIG. 2 is a partially broken away side view of an implement of the invention;

FIG. 3 is a partial perspective view of an implement of the invention in a particular application;

FIG. 4 is a side view of a percussion tool of the invention;

FIG. 5 is a front view of a wrench for use in combination with an implement of the invention;

FIG. 6 is a cross sectional side view of the wrench of FIG. 5.

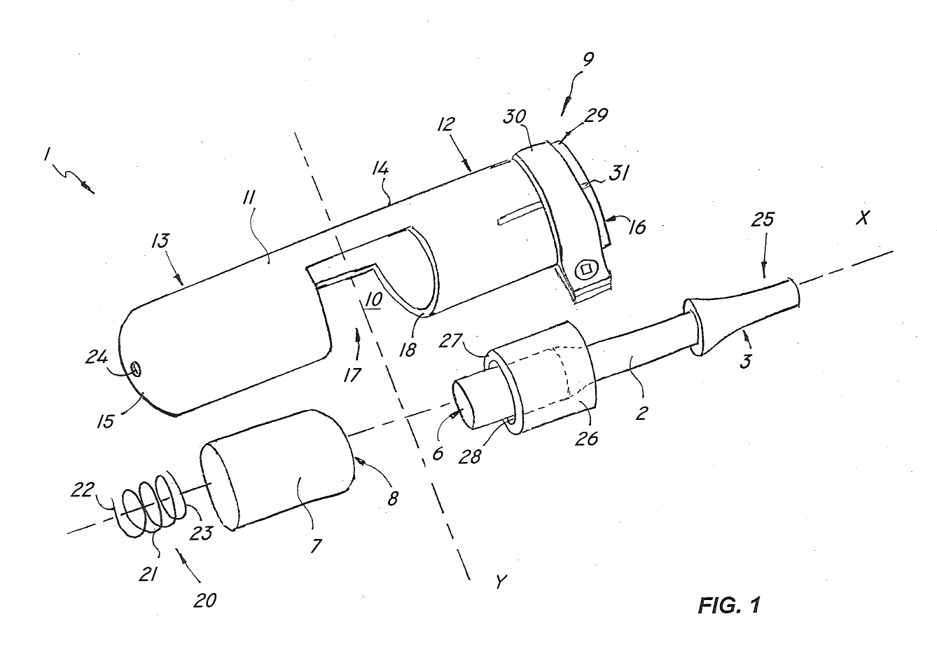

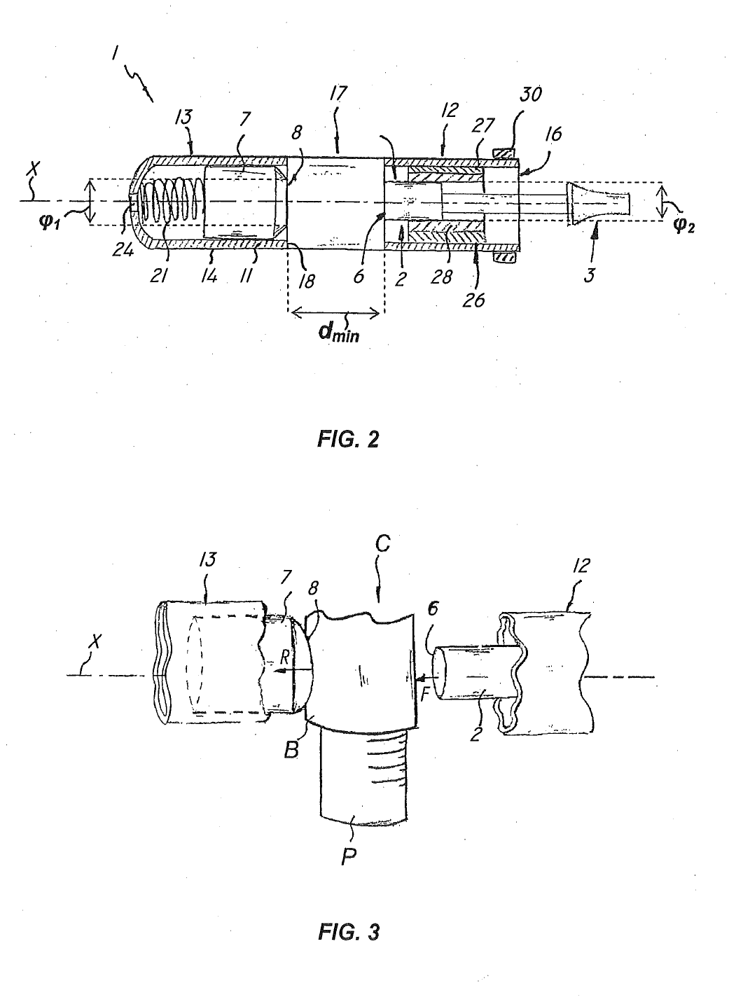

### DETAILED DESCRIPTION OF A PREFERRED EMBODIMENT

Referring to the above figures, an implement for loosening coupled connection elements, generally designated by numeral 1, may be used for loosening couplings of the type comprising at least one pair of elements coupled together, for instance, by screw, interlocking or interference connection.

The implement 1 may be used with nut and screw, dowel and pin assemblies, with bolts or other similar couplings in which two or more mutually coupled contact surfaces have microjunctions caused by oxidation of the outer layers or partial interpenetration thereof.

By way of example and without limitation, the implement 1 of the invention may find application in the field of car repairs, e.g. for loosening threaded coupling in wheel alignment procedures.

An example of application of the implement is shown in FIG. 3, in which a pair C to be loosened comprises a first externally threaded element, such as a pin P and a second internally threaded element, such as a bushing B.

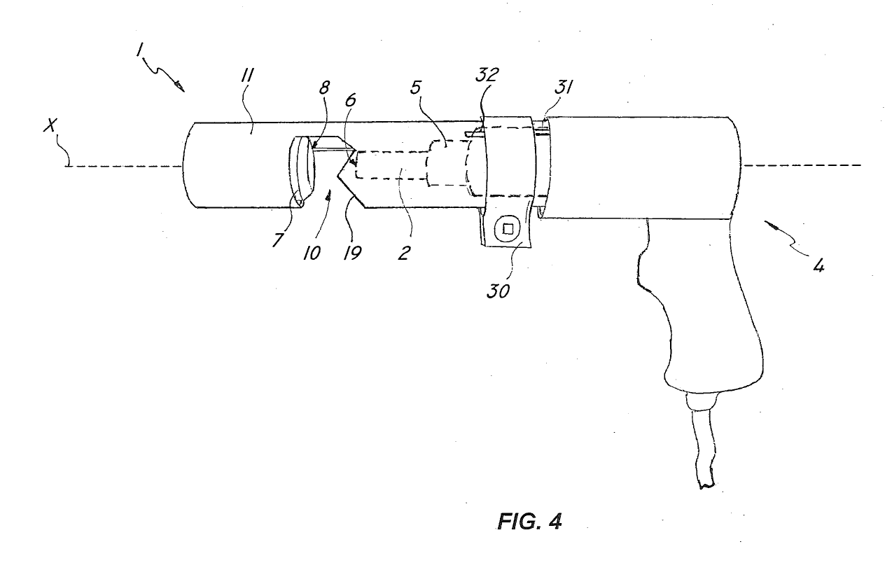

According to the invention, the loosening implement 1 comprises a striking hammer or striker 2 that defines a longitudinal axis X and has a connecting portion 3 at one axial end, designed to be operably secured to an external percussion tool, generally designated by numeral 4 in FIG. 4, the latter being adapted to impart a translational or oscillatory motion to the striker in the axial direction.

Particularly, the connecting portion 3 may be designed to be secured to the chuck 5, which is outlined by broken lines in FIG. 4.

The striker 2 also has a striking surface 6 at the opposite end, which is designed to face towards at least one of the elements P, B of the pair C to interact therewith and impart an impulsive stress F thereto.

A counteracting body 7 facing towards at least one of the elements P, B of the pair C, is provided on the side away from the striker 2 and has a counteracting abutment surface 8 longitudinally offset with respect to the striking surface 6, and designed to contact one of the elements P, B of the coupling C to be loosened, to prevent axial translation thereof while counteracting the impulsive stress F.

According to a peculiar feature of the invention, retaining means 9 are provided for retention of the striker 2 to the counteracting body 7.

Particularly, the retaining means 9 are designed to maintain the striking surface 6 and the abutment surface 8 longitudinally spaced from each other, at a minimum longitudinal distance d_{MIN}, that can adequately define, between the surfaces 6 and 8, an adequate space 10 to accommodate the pair C to be loosened.

In the embodiment as shown in FIG. 3, the pair C to be loosened, consisting of a cylindrical bushing B and a pin P, may be arranged to cause the striker 2 to exert its action on the side surface S of the bushing B. The abutment surface 8 may also be in contact with the side surface S of the bushing B.

Nevertheless, it shall be understood that the implement 1 of the invention may be also used with other types of couplings C, which may be also designed to be disposed in the space 10 with different orientations, for instance with the bushing B and the pin P in axial positions.

According to a preferred configuration of the invention, the retainer means 9 may include a longitudinally elongate tubular frame 11, with a first hollow end portion 12 for receiving the striker 2 and a second hollow end portion 12 for receiving the counteracting body 7.

The tubular frame 11 may have a substantially cylindrical shape with a side wall 14 that is closed by a transverse wall 15 at the second portion 13.

At the first hollow portion 12, the frame 11 may have a transverse opening 16 for access to the striker 2 from the outside and for attachment thereof to the tool 4.

Furthermore a specially shaped opening 17 may be provided on the side wall 16 of the frame 11, for receiving at least one of the elements P and B of the pair C to be loosened, in a substantially radial direction Y.

In the embodiment of the figures, the side opening 17 has substantially regular edges 18 and is formed by removing, e.g. by milling, a substantially cylindrical portion of the side wall 14 of the tubular frame 11.

Nevertheless, the side opening 17 may also have an irregular shape, as shown in FIG. 4, for instance with lateral indents 19 for firm retention of the pair C in the space 10 between the two surfaces 6 and 8.

However, openings 17 of any shape and size may be provided, possibly according to the particular type of pairs C to be loosened.

In a preferred, non-exclusive configuration, the striking surface 6 may be substantially flat and extend in the radial direction. The abutment surface 8 may also be substantially flat and radial, and have a radial dimension φ₁ larger than that φ₂ of the striking hammer 6.

Advantageously, elastic counteracting means 20 may be provided in the tubular frame 11, which exert their action on the counteracting body 7 to push it towards the striker 2 and oppose the retaining reaction R transmitted by the second element B of the pair C as a result of the impulsive stress F.

In a preferred non-limiting embodiment of the invention, the elastic counteracting means 20 may include a spiral spring 21.

The spring 21 may act in a substantially axial direction and have a fixed end turn 22 abutting against the closed wall 15 of the tubular frame 11 and an opposite axially movable end turn 23 abutting against the counteracting body 7.

The closed wall 15 may possibly have a central hole 24 for air to be exhausted during the translational motion of the counteracting body 7 caused by the kickback.

The connecting portion 3 of the striker 2 may have anchor means 25 for removably securing it to an external electrical percussion tool 4 which is adapted to impart a translational or oscillatory motion thereto in the axial direction X.

The anchor means 25 may include a chuck 5 known per se, adapted to be mounted to the percussion tool 4 as typically provided in electrical tools such as power-operated drills and bits.

The chuck 5 may be hollow and adapted to receive and retain the connecting portion 3 of the striker 2 coaxial to the tubular frame 11.

A cylindrical bushing 26 may be also held within the first hollow section 12 of the frame 11 for slideably receiving the striker 2.

The bushing 26 will also have the task of guiding the striker 2 along the longitudinal axis X when a translational or oscillatory motion has been imparted in the axial direction X.

The bushing 26 may consist of an outer cylindrical metal body 27 coaxial with an inner cylindrical body 28.

The inner cylindrical body 28 may have its inner surface, designed for contact with the striker 2, formed of a material with a relatively low coefficient of friction. For instance, the inner cylindrical body 28 may be made of Teflon or similar materials.

Nevertheless, these materials shall not be intended to limit the scope of the present invention, as all the components may be made of metal, plastic or composite materials, according to the mechanical resistance and light-weight requirements associated with each particular application.

The frame 11 may be equipped with removable fastening means 29 for removable connection thereof to the percussion tool 4.

For instance, the fastening means 29 may include a clamp 30 to be closed at its ends over a longitudinal slot 31 of the frame 11 for removably fastening it to the electrical tool 4.

In another aspect, the invention relates to a tool 4 for loosening threaded couplings C, which is adapted to be connected to the above described implement 1 and further comprises a head 32 susceptible of oscillating in a longitudinal direction X.

The tool 4 may be a known electrical tool, namely a pneumatic percussion bit, not necessarily specially designed for operation with the implement 1 of the invention. The head 32 may be equipped with the removable chuck 5, for the implement 1 of the invention to be removably secured thereto.

Thus, the head 32 will transmit an oscillatory motion to the striker 2 along a longitudinal axis X, for the latter to transmit one or more impulsive stresses F to one of the elements P, B of the pair C to be loosened, placed in the space 10.

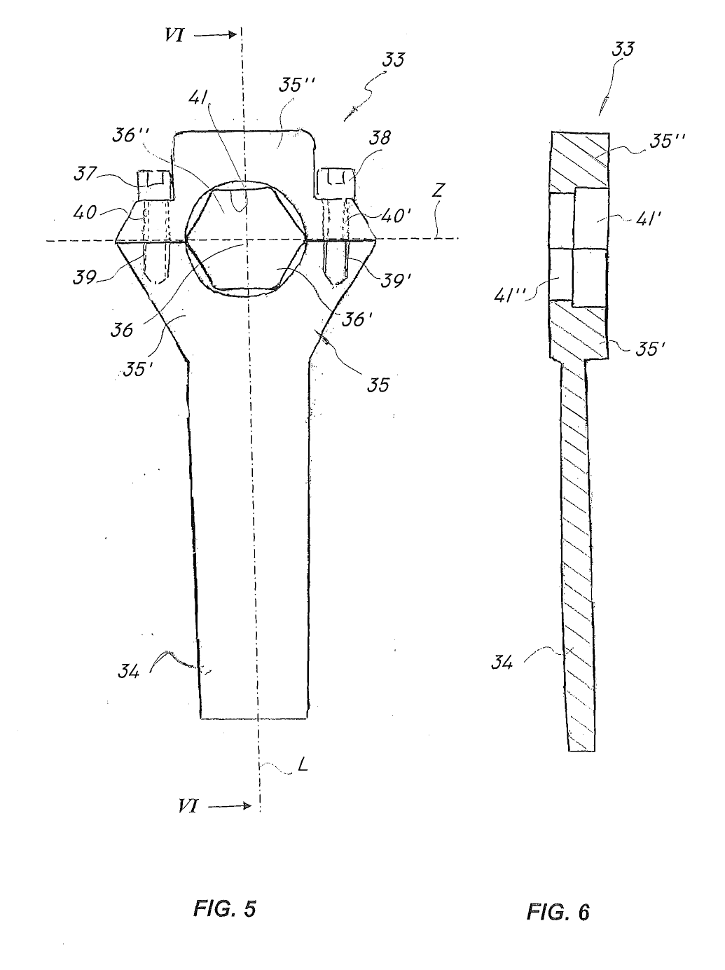

FIGS. 5 and 6 shows an auxiliary wrench 33 designed for use in combination with the implement 1 for engaging one of the connection elements of the pair C to be loosened, such as the element P, to promote rotation thereof and facilitate unscrewing of the pair C.

The wrench 33 may be supplied in combination with the implement 1 of the invention and/or the percussion tool 4 to form a loosening kit.

Nevertheless, the particular features of the wrench 33, as described below, will also allow it to be used alone, without the implement 1 and the tool 4.

In other words, the loosening effect may be also obtained by the wrench 33 only.

The wrench has a handle 34 that allows it to be held by a user, and a gripping ring 35 that has a central seat 36 for at least partially accommodating one of the elements P to be loosened.

The ring 35 has a first portion 35′ integral with the handle 34 and a second portion 35″, removably secured to the first portion 35′ by removable anchor means, to allow the seat 36 to be opened and receive the element P to be loosened.

In a preferred, non-limiting embodiment of the invention, the handle 34 substantially extends along a main axis of extension L. The two ring portions 35′, 35″ are substantially symmetrical with respect to an axis transverse to the axis of extension L.

The two portions 35′, 35″ may be removably secured to each other by a pair of screws 37, 38, bolts or similar members, which engage respective pairs of aligned holes formed on both ring portions 35′, 35″.

Particularly, the first ring portion 35′ has a pair of blind holes 39, 39′ and the second ring portion 35″ has a pair of through holes 40, 40′ adapted to be aligned with respective blind holes 39, 39′.

When the two ring portions 35′, 35″ are secured to each other, the seat 36 will be closed and define a side wall 41 suitably shaped according to the particular application for which it is intended.

Particularly, the shape of the side wall 41 of the seat 36 may be selected according to the cross section of the element P of the pair C to be loosened, for which the wrench 33 is designed.

In the illustrated embodiment, which is particularly advantageous, the side wall 41 of the seat 36 has a first substantially cylindrical axial portion 41′, and a second axial portion 41″ adjoining the first portion and having a substantially prismatic shape.

Particularly, the second axial portion 41″ has a hexagonal profile, to engage a hexagonal connection element P.

In operation, in order to engage the wrench 33 with one of the elements P to be loosened, the two ring portions 35′, 35″ will be released by removing the retainer means 37, 38 and thus access will be provided to the central seat 36, that will be divided into two halves 36′, 36″.

Then, the element P to be loosened will be placed in the half 36′ of the seat 36 defined by the first ring portion 35′. Now, the second portion 35″ will be mounted thereupon, to form the seat 36 with the element P to be loosened is enclosed therein. Finally, the two ring portions 35′, 35″ will be secured to each other, allowing the required unscrewing torque to be exerted on the element P to be loosened.

If the wrench 33 is to be combined with the implement 1, it may be used at the same time as the implement 1, thereby allowing the torque to be imparted at the same time as the impulsive stress F.

However, the wrench 33 may be also used before or after using the implement 1.

It shall be reminded that the wrench 33 may be also used without the implement 1 and/or the percussion tool 4 and will not necessarily be part of a kit according to the present invention.

In this case, the wrench 33 will maintain its advantages, namely the ability of forming a closed seat 36 for the element P to be loosened, and thus of exerting a higher torque and preventing disengagement of the element P to be loosened, but will still be able to be opened, and thus to be used even when the elements to be loosened are hardly accessible.

The implement, tool, wrench and kit of the invention are susceptible to a number of changes or variants, within the inventive concept disclosed in the appended claims. All the details thereof may be replaced by other technically equivalent parts, and the materials may vary depending on different needs, without departure from the scope of the invention.

While the implement, tool, wrench and kit have been described with particular reference to the accompanying figures, the numerals referred to in the disclosure and claims are only used for the sake of a better intelligibility of the invention and shall not be intended to limit the claimed scope in any manner.

The invention claimed is:

1. An implement for loosening stuck connection elements, for use with percussion tools having a chuck, comprising:
a striker having at one end a connecting portion, adapted to be secured to a chuck of a percussion tool and at another end a striking surface, designed to impart an impulsive stress;
a counteracting body opposing said striker and having an abutment surface facing towards said striking surface to counteract said impulsive stress; and
a retainer for retaining said striker to said counteracting body at a predetermined distance between said striking surface and said abutment surface, the retainer being adapted to accommodate at least one of the elements of a pair of connecting elements to be loosened.

2. The implement as claimed in claim 1, wherein said retainer includes a longitudinally elongate tubular frame having a first hollow end section for receiving said striker and a second hollow end section for receiving said counteracting body.

3. The implement as claimed in claim 2, wherein said tubular frame has a side wall with an opening adapted to receive the pair to be loosened between said striking surface and said abutment surface in a substantially radial direction.

4. The implement as claimed in claim 2, wherein said striking surface of said striker is substantially flat and extends in a lateral direction.

5. The implement as claimed in claim 2, wherein said abutment surface extends in a substantially lateral direction, with a radial dimension larger than a radial dimension of said striking surface of said striker.

6. The implement as claimed in claim 5, n wherein said tubular frame encloses elastic counteracting means which exert their action on said counteracting body to push said counteracting body towards said striker and oppose a retaining reaction transmitted by the pair as a result of said impulsive stress.

7. The implement as claimed in claim 6, wherein said elastic counteracting means include a spring operating in a substantially axial direction and having a fixed end associated with said tubular frame and an opposite axially movable end operating against said counteracting body.

8. The implement as claimed in claim 2, wherein said connecting portion of said striker has anchor means for securing said striker to a percussion tool adapted to impart a plurality of successive longitudinal oscillations to said striker.

9. The implement as claimed in claim 8, wherein said anchor means include the chuck which is designed to be mounted to said percussion tool and has a cavity for receiving and holding said connecting portion of said striking hammer coaxial to said tubular frame.

10. The implement as claimed in claim 2, wherein said first end section of said tubular frame has a cylindrical bushing therein, for guiding said striker along a longitudinal axis during a longitudinal oscillatory motion of said striker.

11. The implement as claimed in claim 2, wherein said tubular frame has means for removably fastening said tubular frame to an external percussion tool.

12. A percussion tool for loosening coupled connection elements, comprising:
a head susceptible of swinging along a longitudinal axis and the implement of claim 1, the implement being designed to be removably secured to said head for receiving an oscillatory motion in a longitudinal direction,
wherein said implement comprises the striker with the connecting portion designed to be removably secured to said head to receive said oscillatory motion and respond to said oscillatory motion by imparting the impulsive stress to the pair of connecting elements to be loosened.

13. A kit for loosening stuck connection elements comprising:
the implement as claimed in claim 1; and
an auxiliary wrench configured to be used on one of the connection elements to be loosened to promote rotation thereof at a same time as or after exertion of the impulsive stress by said striking surface.

14. The kit as claimed in claim 13, wherein said auxiliary wrench comprises a handle designed to be held by a user and a gripping ring having a central seat for partially accommodating one of said elements to be loosened, said ring comprising a first portion integral with said handle and a second portion removably retained to said first portion to allow said seat to be opened and receive the one of said elements to be loosened.

15. The kit as claimed in claim 14, wherein said seat has a side wall having a first substantially cylindrical axial portion and a second substantially prismatic axial portion adjoining said first axial portion.

16. The kit as claimed in claim 13, further comprising a percussion tool having:
a head susceptible of swinging along a longitudinal axis and said implement, the implement being designed to be removably secured to said head for receiving an oscillatory motion in a longitudinal direction,
wherein said implement comprises the striker with the connecting portion designed to be removably secured to said head to receive said oscillatory motion and respond to said oscillatory motion by imparting the impulsive stress to the pair of connecting elements to be loosened.
